(19) United States
(12) Patent Application Publication
(10) Pub. No.: US 2015/0083659 A1
(43) Pub. Date: Mar. 26, 2015

(54) BICOMPONENT FIBER WITH SYSTEMS AND PROCESSES FOR MAKING

(71) Applicant: BHA Altair, LLC, Franklin, TN (US)

(72) Inventors: Vishal Bansal, Overland Park, MO (US); Jeffery Michael Ladwig, Overland Park, KS (US)

(73) Assignee: BHA Altair, LLC, Franklin, TN (US)

(21) Appl. No.: 14/036,436

(22) Filed: Sep. 25, 2013

(51) Int. Cl. D06M 15/256; D03D 15/00; B01D 71/04; B01D 71/36; D02J 3/18; B32B 38/00

(52) U.S. Cl. CPC D06M 15/256; D02J 3/18; B32B 38/00; B01D 71/04; B01D 71/36; D03D 15/0011
USPC 210/500.26; 428/392; 442/189; 442/324; 428/319.7; 118/600; 427/389.8; 264/103; 156/148; 28/143

(57) ABSTRACT

A bicomponent fiber is disclosed, in addition to systems and processes for making the bicomponent fiber. The bicomponent fiber can include a glass core and a polytetrafluoroethylene (PTFE) sheath circumferentially enclosing the glass core, wherein the bicomponent fiber has a diameter between approximately five micrometers and approximately twenty micrometers.

### BACKGROUND OF THE INVENTION

The present disclosure relates to a bicomponent fiber, in addition to systems and processes for making the bicomponent fiber. More particularly, the present disclosure relates to increasing the versatility of fibers and fiber products while reducing costs.

Fabrics and fiber components serve important technical purposes in a variety of fields, including industrial and air filtration. Depending on need, fibers may be processed into a variety of materials. Fibers of different composition can be used to form selectively or “semi-permeable” substances. The physical properties of a fabric or fiber-based product depend from the substances used in each individual fiber. For example, changing the structure of a fiber can influence resilience to external factors or affect the costs of production.

### BRIEF DESCRIPTION OF THE INVENTION

A first aspect of the disclosure provides a bicomponent fiber comprising a glass core; and a polytetrafluoroethylene (PTFE) sheath circumferentially enclosing the glass core; wherein the bicomponent fiber has a diameter between approximately five micrometers and approximately twenty micrometers.

A second aspect of the disclosure provides a system for making a bicomponent fiber, the system comprising: a container having an inlet and an outlet; an aqueous dispersion within the container, wherein the aqueous dispersion includes polytetrafluoroethylene (PTFE); and a heated surface configured to receive a core fiber coated with the aqueous dispersion from the outlet of the container, wherein the heated surface sinters the coated aqueous dispersion into a sheath.

A third aspect of the invention provides a process of making a bicomponent fiber, the process comprising: passing a glass fiber through an aqueous dispersion including polytetrafluoroethylene (PTFE) to coat the glass fiber with the aqueous dispersion, thereby yielding a PTFE coat of the glass fiber; and contacting the PTFE coat of the glass fiber with a heated surface to form a PTFE sheath, wherein the PTFE sheath circumferentially encloses the glass fiber, thereby yielding the bicomponent fiber.

### BRIEF DESCRIPTION OF THE DRAWING

These and other features of the disclosed system will be more readily understood from the following detailed description of the various aspects of the system taken in conjunction with the accompanying drawings that depict various embodiments, in which:

FIG. 1 is a cross-sectional diagram of a bicomponent fiber according to an embodiment of the disclosure.

FIG. 2 is a perspective view of a laminate made from a bicomponent fiber according to an embodiment of the invention.

FIG. 3 is a perspective view of a woven fabric made from a bicomponent fiber according to an embodiment of the invention.

FIG. 4 is a cross-sectional diagram of a needle felt fabric made from a bicomponent fiber according to an embodiment of the invention.

FIG. 5 is a perspective view of a filter bag with materials made from a bicomponent fiber according to an embodiment of the invention.

FIG. 6 is a perspective view of a pleated filter element with materials made from a bicomponent fiber according to an embodiment of the invention.

FIG. 7 is a schematic diagram of a system for making a bicomponent fiber according to an embodiment of the disclosure.

FIG. 8 is a schematic flow diagram of a process of making a bicomponent fiber according to an embodiment of the disclosure.

It is noted that the drawings are not necessarily to scale. The drawings are intended to depict only typical aspects of the disclosure, and therefore should not be considered as limiting its scope. In the drawings, like numbering represents like elements between the drawings.

### DETAILED DESCRIPTION OF THE INVENTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

Embodiments of the present disclosure include a bicomponent fiber. The bicomponent fiber can include a glass core enclosed by a polytetrafluoroethylene (PTFE) sheath. In some circumstances, the bicomponent fiber can have a diameter between approximately five micrometers and approximately twenty micrometers.

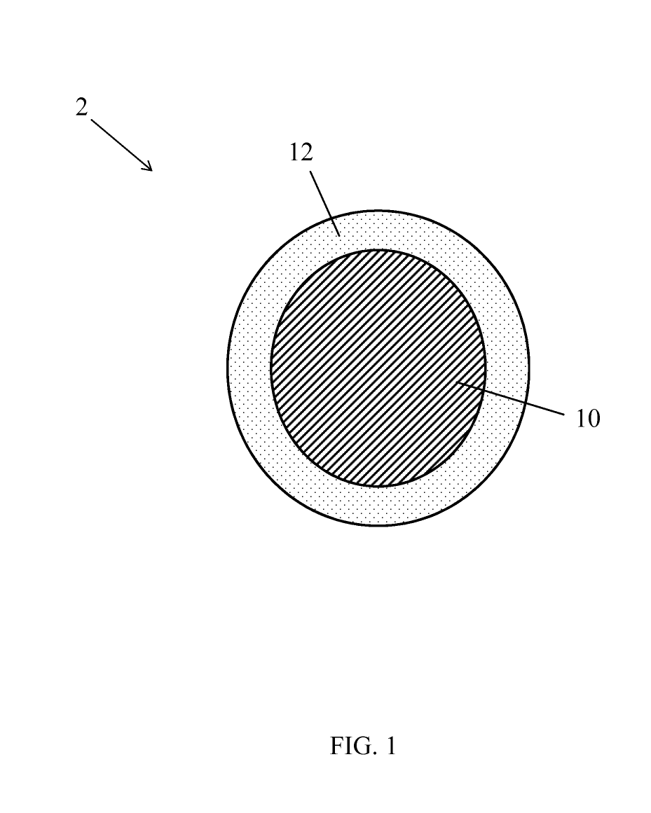

Referring to the drawings, FIG. 1 depicts a bicomponent fiber 2 according to an embodiment of the disclosure. Bicomponent fiber 2 can include a core 10 of a material that can substantially maintain its structural integrity by not failing or melting at temperatures exceeding approximately 250° C. Specifically, core 10 can include glass materials or derivatives. As one example, core 10 can be made from a texturized glass filament. Some materials used in core 10, such as glass, may not have a corresponding ability to withstand acidic environments. For the purposes of comparison, the properties of other acid-resistant materials such as polymers are discussed elsewhere herein. In some embodiments, core 10 can include a glass core with a coefficient of thermal expansion approximately equal to 4.0×10⁻⁶ meters over meters per kelvin (sometimes abbreviated as “m/m/K” or “/K”).

In an embodiment, bicomponent fiber 2 can further include a sheath 12 circumferentially enclosing core 10. Sheath 12 can generally include any currently known or later developed material with acid-resistant properties, such as a polymer. The acid resistance of sheath 12 is discussed in further detail elsewhere herein. In some embodiments, sheath 12 can be a layer circumferentially enclosing core 10. Sheath 12 can be deposited according to systems and processes discussed elsewhere herein.

Sheath 12 can include a polymer such as polytetrafluoroethylene (PTFE), with material properties that prevent sheath 12 from reacting, disintegrating, or otherwise failing when exposed to acidic environments. In some embodiments, sheath 12 can maintain structural integrity when exposed to an acid having a pH of approximately 2.0 or less. The acid-resistant properties of sheath 12 can also accompany resistance to high temperatures, such as temperatures above 250° C. However, sheath 12 need not maintain structural integrity over the same range of temperatures as the material used in core 10. Sheath 12 can also have a coefficient of thermal expansion that is significantly different from materials used in core 10. Where sheath 12 includes PTFE, the coefficient of thermal expansion of sheath 12 can be approximately equal to 135.0×10⁻⁶ m/m/K.

Bicomponent fiber 2 can be customized to have desired size or shape. In specific applications such as air filtration and industrial filtration, bicomponent fiber 2 can have a diameter between approximately five micrometers and approximately twenty micrometers. In more specific applications, bicomponent fiber 2 can have a diameter between approximately five micrometers and ten micrometers. The size of bicomponent fiber 2 can allow bicomponent fiber 2 to be deployed or used as a weavable fabric. Specifically, bicomponent fiber 2 can be used in filtration devices, such as filter paper materials or filter bags.

Bicomponent fiber 2, by having a core 10 and sheath 12 with the properties described herein, can be deployed in a broader context of situations than each of the components used in core 10 and/or sheath 12 alone. In particular, the acid-resistant properties of sheath 12 can allow bicomponent fiber 2 to be applied in acidic environments with a pH value of at most approximately 2.0. Sheath 12 can remain structurally stable and may not react, disintegrate, or otherwise fail when exposed to acids. Thus, the properties of sheath 12 can also protect the structural integrity of core 10.

Similarly, sheath 12 and/or core 10 can remain structurally stable when exposed to high-temperature environments. In some embodiments, sheath 12 can conduct heat. Due to its design, bicomponent fiber 2 can retain the temperature-resistant properties of both glass and PTFE. Both core 10 and sheath 12 can absorb heat or thermal energy from the environment. As a result, both core 10 and sheath 12 of bicomponent fiber 2 can be applied in environments having temperatures exceeding 250° C. This property reduces the risk of damage, structural breakdown, melting, or other temperature-related failure.

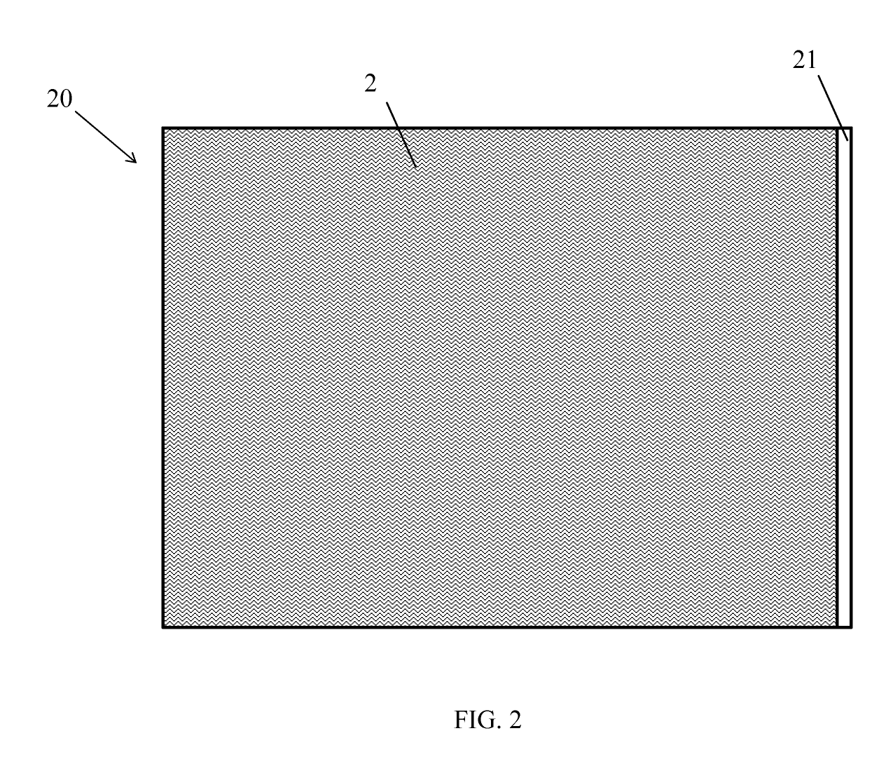

As shown in FIG. 2, embodiments of bicomponent fiber 2 can be converted into a laminate 20. Bicomponent fibers 2 capable of conversion to laminate 20 can have a diameter between approximately five micrometers and approximately twenty micrometers. In other embodiments, bicomponent fiber 2 can have a diameter between approximately five micrometers and approximately ten micrometers.

Bicomponent fiber 2 can be converted into laminate 20 according to currently known or later developed methods for weaving fibers or other weavable substances into a continuous fabric. The resulting fabric can be laminated to a membrane 21. Some examples of processes for creating laminate 20 are discussed elsewhere herein.

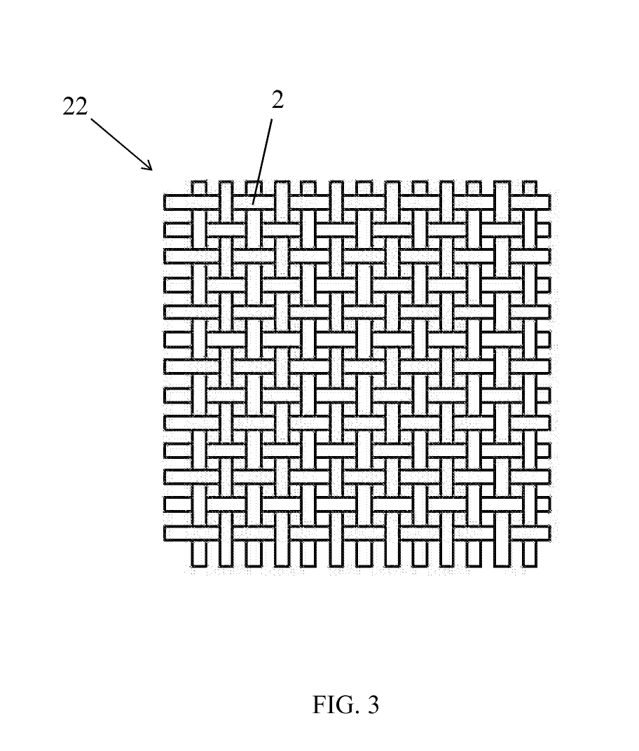

Turning to FIG. 3, a woven fabric 22 is shown. Woven fabric 22 can be composed of bicomponent fiber 2 (FIG. 1). Similar to conventional threads, bicomponent fiber 2 can be subjected to weaving via currently known or later developed processes for forming a fabric. The resulting woven fabric 22 may have some (or all) of the properties of bicomponent fiber 2. Woven fabric 22 can therefore be used in various applications and to form filtration equipment, as discussed elsewhere herein.

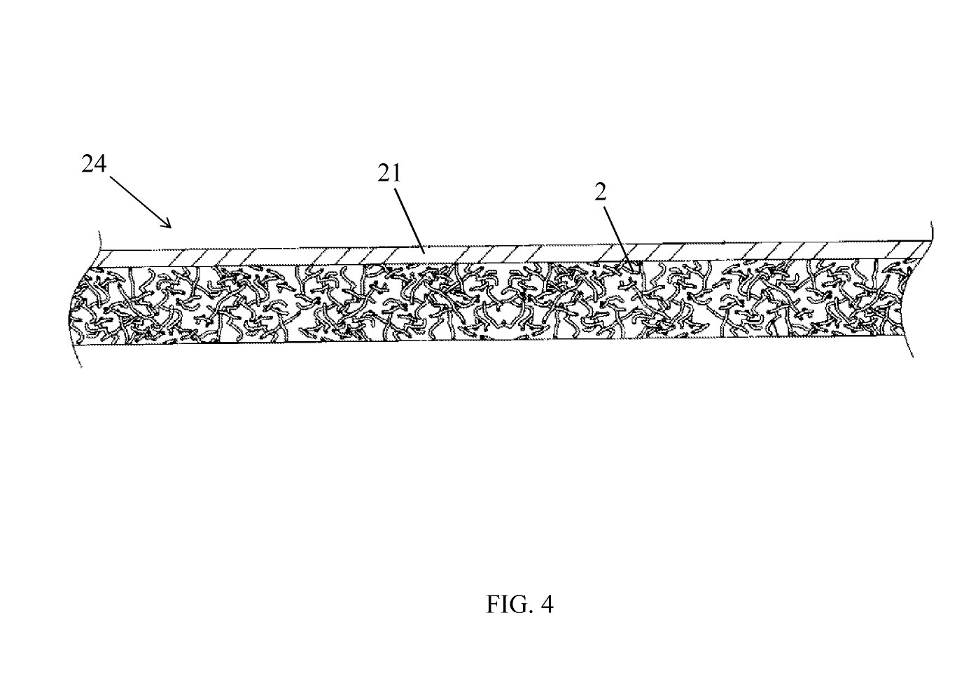

In FIG. 4, a needle felt fabric 24 is shown. As known in the art, a needle felt fabric may refer to a material in which individual fibers are entangled with each other to form a fibrous structure. Similar to laminate 20 (FIG. 2), needle felt fabric 24 may include several bicomponent fibers 2 (FIG. 1) laminated to membrane 21. Needle felt fabric 24 may have some (or all) of the properties of bicomponent fiber 2. Needle felt fabric 24 may also be applied in this form or used to create filtration equipment, as discussed elsewhere herein.

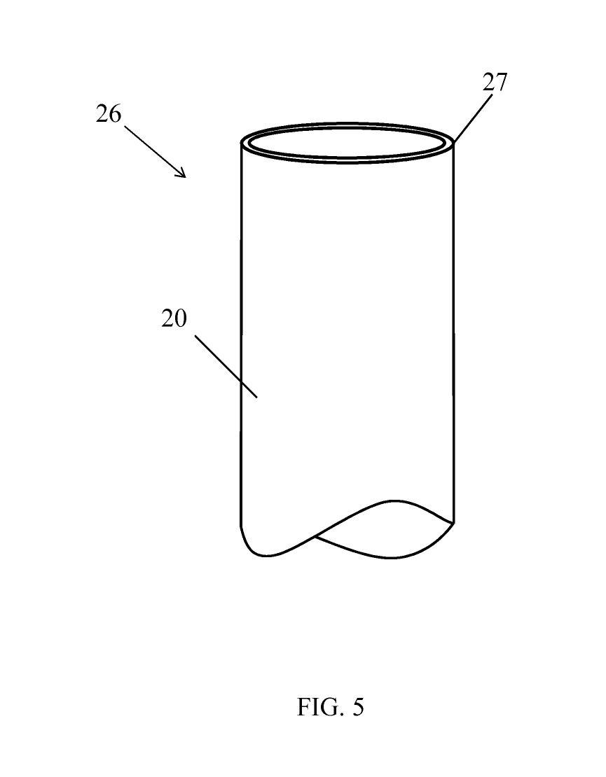

As shown in FIG. 5, laminate 20 of bicomponent fiber 2 (FIGS. 1, 2) and/or woven and needle felt fabrics 22, 24 (FIGS. 3, 4) can be used to form a filtration device. According to the example shown in FIG. 5, laminate 20 of one or more bicomponent fibers 2 (FIGS. 1, 2) can be used to form a filter bag 26 from laminate 20. Although filter bag 26 is shown to be made from laminate 20, filter bag 26 can also be made from woven and needle felt fabrics 22, 24 (FIGS. 3, 4). Filter bag 26 can be implemented in a variety of situations, including industrial or air filtration. For example, some substances can pass through laminate 20 of filter bag 26, while other substances will be stopped and retained within filter bag 26. In addition, filter bag 26 can include a retaining member 27, to which laminate 20 may be affixed. In the example of FIG. 5, retaining member 27 is substantially annular. In this manner, filter bag 26 can have a desired structure.

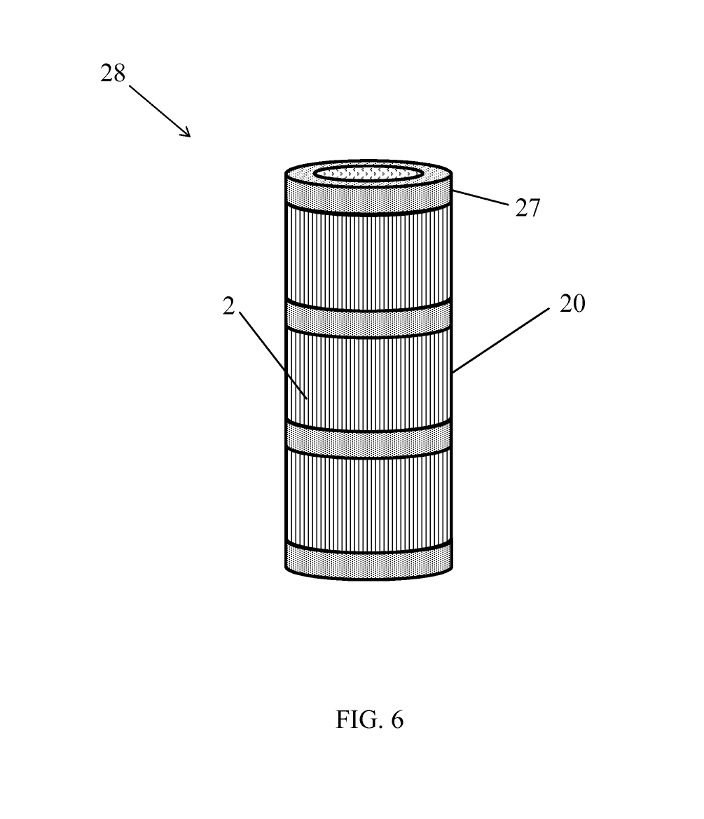

FIG. 6 depicts a pleated filter element 28 which may also be made from laminate 20 of bicomponent fiber 2 (FIGS. 1, 2) and/or woven and needle felt fabrics 22, 24 (FIGS. 3, 4). Pleated filter element 28 is another piece of filtration equipment which may offer the acid resistance and temperature resistance of bicomponent fiber 2. Similar to filter bag 26, retaining member 27 can be affixed to at least one laminate 20. Several laminates 20 can be affixed to retaining member 27 to form a “pleated” filter structure of pleated filter element 28. Although FIG. 6 depicts a pleated filter element 28 with laminate 20 by way of example, pleated filter element 28 can also be made with woven and needle felt fabrics 22, 24 (FIGS. 3, 4). Through the use of bicomponent fiber 2 (FIG. 1), pleated filter element 28 can exhibit the acid and temperature resistant properties discussed elsewhere herein.

Laminate 20, woven fabric 22, needle felt fabric 24, filter bag 26, and/or pleated filter element 28 can be used in various filtration applications. For example, laminate 20, woven fabric 22, and/or needle felt fabric 24 can be used to make a physical filter such as a semi-permeable felt structure, filter paper, and/or woven fabric. In addition, each material made from bicomponent fiber 2 (FIG. 1) can have some or substantially all of physical properties of core 10 (FIG. 1) and sheath 12 (FIG. 1), including resistance to acidic environments with a pH of approximately 2.0 or less and/or temperatures greater than approximately 250° C.

In addition to bicomponent fiber 2 and materials made therefrom (e.g., laminate 20 (FIG. 2), fabrics 22, 24 (FIGS. 3, 4), filter bags 26 (FIG. 5), and pleated filter element 28 (FIG. 6)), the present disclosure also contemplates a system and process of making bicomponent fiber 2.

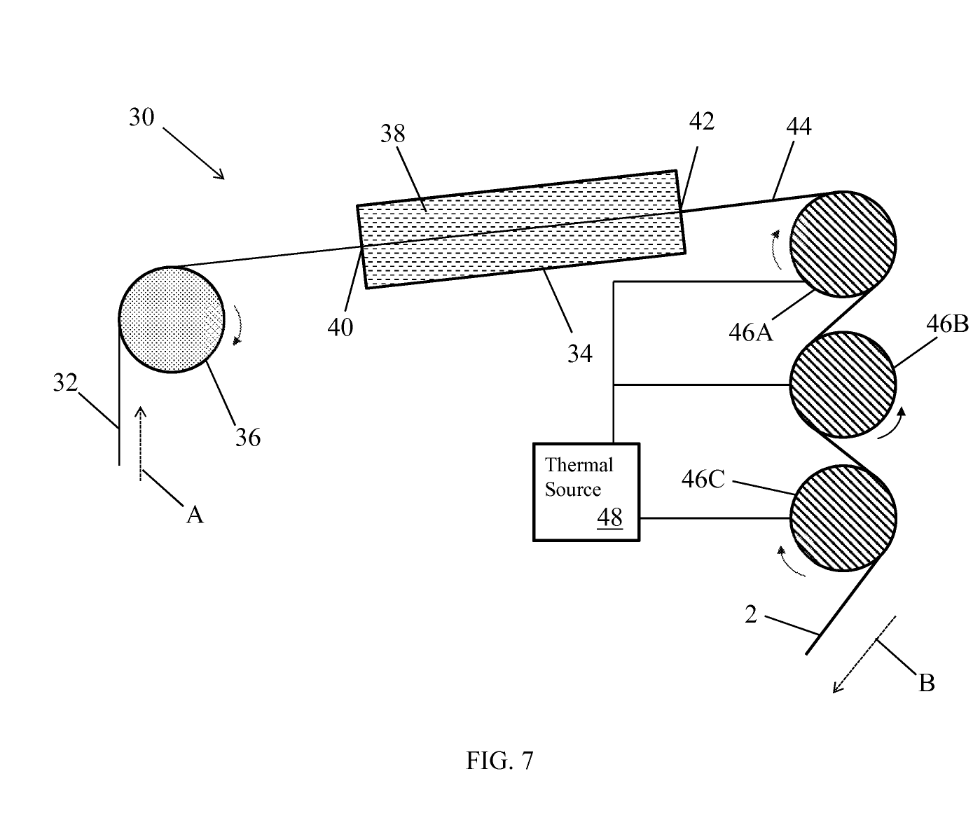

Turning to FIG. 7, an embodiment of a system 30 for making a bicomponent fiber 2 is shown. System 30 can operate on a core fiber 32. Core fiber 32 can include materials discussed elsewhere herein with respect to core 10 (FIG. 1), such as a texturized glass filament. Core fiber 32 can be processed along the direction of phantom line A to enter a container 34, optionally with the aid of a first roller 36.

Container 34 can be a tank, bath, box, or another equivalent structure for housing liquid and/or solid materials. Container 34 can include a reserve of sheathing materials 38 capable of contacting core fiber 32 and remaining thereon. In an embodiment, sheathing materials 38 can be in the form of an aqueous dispersion. In this case, sheathing materials 38 can be a powder of substances similar to or the same as those discussed elsewhere herein with respect to sheath 12 (FIG. 1), including PTFE. The powder of sheathing materials 38 can be added to a liquid to form an aqueous dispersion. In some embodiments, sheathing materials 38 is an aqueous dispersion that includes approximately 60% PTFE. System 30 can include one container 34 or multiple containers 34 arranged in succession. Increasing the number of containers may improve the deposition of sheathing materials 38 on core fiber 32.

In an embodiment, container 34 can include an inlet 40 and an outlet 42 between the inside of container 34 and the environment. Inlet 40 can allow core fiber 32 to enter container 34 and contact sheathing materials 38. Outlet 42 can allow core fiber 32 to exit container 34. Thus, inlet 40 and outlet 42 can allow passage of core fiber 32 through container 34.

Core fiber 32, following passage through sheathing materials 38 of container 34, can become a coated core fiber 44. Coated core fiber 44 contains a layer of sheathing materials 38 provided thereon. In some embodiments, core fiber 44 can include approximately 20% of sheathing materials by weight of core fiber 32. To form sheath 12 (FIG. 1) of bicomponent fiber 2, coated core fiber 44 can contact one or more heated surfaces as described herein.

In an embodiment, coated core fiber 44 can pass over three heated rollers 46A, 46B, 46C. Heated rollers 46A, 46B, 46C can include, for example, an industrial roller currently known or later developed. Each heated roller 46A, 46B, 46C can be supplied with heat energy from a thermal source 48. In specific embodiments, heated rollers 46A, 46B, 46C can be sintering rolls. Although thermal source 48 is shown to be one unit distinct from each of heated rollers 46A, 46B, 46C, system 30 can include several thermal sources 48, each of which can optionally be directly coupled to heated rollers 46A, 46B, 46C. Other embodiments of the present disclosure can, for example, include only one heated roller, or as many heated rollers as desired. Alternatively, other currently known or later developed heated surfaces can be used in system 30 to transfer heat to coated core fiber 44.

System 30, through heated surfaces such as heated rollers 46A, 46B, 4C, can cause sheathing materials 38 to become a coated sheath on core fiber 32. For example, PTFE can sinter when subjected to heat. In an embodiment, heated surfaces of rollers 46A, 46B, 46C can be at a temperature of approximately 350° C. Therefore, heat applied from heated rollers 46A, 46B, 46C can sinter sheathing materials 38 into a solid sheath circumferentially enclosing core fiber 32. Bicomponent fiber 2 is yielded from heated rollers 46A, 46B, 46C along line B as a result. As discussed elsewhere herein, bicomponent fiber 2 can be processed, optionally along with other bicomponent fibers 2, to create derivative substances such as laminate 20 (FIGS. 2, 3) and filter bag 26 (FIG. 5).

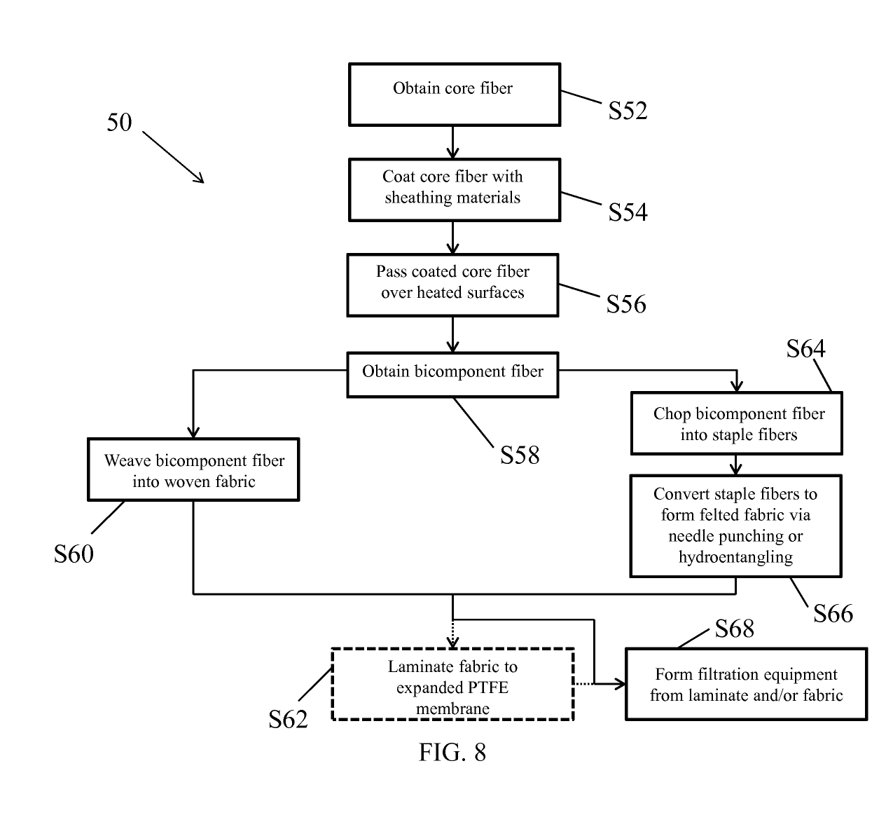

Turning to FIG. 8, a flow diagram representing an embodiment of a process 50 for making a bicomponent fiber is shown. Process 50 can use any of the equipment discussed herein with respect to system 30, and/or their equivalents. Process 50 can operate on a core fiber 32 (FIG. 7) in step S52, with core fiber 32 (FIG. 7) being provided from a user or machine.

Core fiber 32 (FIG. 7) can be coated with sheathing materials 38 in step S54, for example, by entering a container 34 (FIG. 7) in step S54. Sheathing materials 38 (FIG. 7) of coated core fiber 44 (FIG. 7) can sinter in response to being passed over heated surfaces in step S56. Bicomponent fiber 2 (FIG. 1) can be obtained in step S58 of process 50 as a result of contacting heated surfaces (e.g., heated rollers 46A, 46B, 46C (FIG. 7)). In some embodiments, bicomponent fiber 2 (FIG. 1) yielded from process 50 can have a diameter between approximately five micrometers and approximately twenty micrometers. In other embodiments, bicomponent fiber 2 can have a diameter between approximately five micrometers and approximately ten micrometers.

Bicomponent fiber 2 (FIG. 1) can be further modified in additional, optional steps of process 50. As an example, bicomponent fiber 2 (FIG. 1) can be weaved in step S60 into a woven fabric. Woven fabrics yielded from process 50 can include some or substantially all of the acid and temperature resistant properties discussed elsewhere herein with respect to bicomponent fiber 2 (FIG. 1).

Embodiments of process 50 can optionally include a further step S62 (shown in phantom) of making materials such as laminate 20 (FIG. 2) from the woven fabric yielded from step S60. As one example, a user or system can in step S62 laminate the woven fabric to an expanded PTFE membrane 21 (FIG. 2) of PTFE to form a laminate 20 (FIG. 2). A user can also form laminate 20 (FIG. 2) according to equivalent processes currently known and later developed. Laminate 20 (FIG. 2) can have some or substantially all of the same temperature and acid resistant properties described elsewhere herein with respect to bicomponent fiber 2 (FIG. 1).

A further option for processing bicomponent fiber 2 (FIG. 1) in process 50 can include chopping bicomponent fiber 2 into staple fibers in Step S64. Staple fibers in step S64 can be used to form a felted fabric by any currently known or later developed process, such as needle punching or hydroentangling, in step S66. The resulting felted fabric can include some or substantially all of the acid and temperature resistant properties of individual bicomponent fibers 2 discussed elsewhere herein. In addition, felted fabrics yielded from step S66 can optionally be converted into a laminate 20 (FIG. 2) by laminating the felted fabric to an expanded PTFE membrane 21 (FIG. 2) as discussed elsewhere herein with respect to step S62.

Fabrics or laminate 20 (FIGS. 2-4) yielded from any of steps S60, S62, and S68 can be processed into filtration equipment. As an example, a user of process 50 in step S68 can form filter bag 26 (FIG. 5) by affixing a fabric or laminate 20 (FIG. 2) to a structural component. For instance, filter bag 26 (FIG. 5) can be formed by affixing fabrics and/or laminate 20 (FIGS. 2-4) to retaining member 27 (FIG. 5) according to any currently known or later developed process for forming a bag, such as adhesive bonding.

In addition to the processes described herein, including the example flow diagram of FIG. 8, other methods of making a bicomponent fiber 2 (FIG. 2) are contemplated. As one example, a film of sheathing materials (FIG. 7) such as PTFE can be rolled circumferentially around core fiber 32 (FIG. 7). Core fiber 32 can be a glass filament core or a glass-based yarn. The rolled film of sheathing materials 38 (FIG. 7) and core fiber 32 (FIG. 7) can then be heated to a temperature of approximately 350° C. The heating can allow the film of sheathing materials 38 (FIG. 7) to form a continuous sheath about core fiber 32 (FIG. 7). In an embodiment, the film of sheathing materials can include PTFE. The resulting bicomponent fiber 2 (FIG. 1) can have a diameter between approximately five micrometers and twenty micrometers, or between approximately five micrometers and ten micrometers.

Making bicomponent fiber 2 (FIG. 1) according to the film coating and heating process described herein produces a component that can also be further processed into other materials or devices. For example, bicomponent fiber 2 can be chopped and pressed into a felt structure. In other embodiments, bicomponent fiber 2 (FIG. 1) can be processed into a woven fabric. In additional embodiments, bicomponent fiber 2 (FIG. 1) can be woven into a laminate structure 20 (FIG. 2), a fabric (FIGS. 3, 4), a filter bag 26 (FIG. 5), and/or a pleated filter element 28 (FIG. 6). These resulting structures can have some or substantially all of the acid or temperature resistant properties discussed elsewhere herein.

The various embodiments discussed in the present disclosure can offer several technical and commercial advantages. An advantage that may be realized in the practice of some embodiments of the described apparatuses is a fiber applicable to industrial filtration applications, such as air filtration, that includes both heat and acid resistant properties. Some potential applications for bicomponent fiber include use in hazardous waste generators, kilns, industrial waste incinerators, and radioactive waste incinerators. A further advantage is that bicomponent fiber 2 (FIGS. 1, 2, 4) can be deployed without an additional surface coating upon sheath 12 (FIG. 1).

The ability to combine a core fiber of glass with a sheath of PTFE through the processes described herein is a departure from the art in that each of the combined materials may have significantly different coefficients of thermal expansion. Thus, system 30 (FIG. 7) and process 50 (FIG. 8) described herein allow the advantageous properties of each material to be present in a single fiber. Further, significant cost savings can be achieved with bicomponent fibers of glass and PTFE as compared to single-component fibers of PTFE alone.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A bicomponent fiber comprising:
a glass core; and
a polytetrafluoroethylene (PTFE) sheath circumferentially enclosing the glass core;
wherein the bicomponent fiber has a diameter between approximately five micrometers and approximately twenty micrometers.

2. The bicomponent fiber of claim 1, wherein the bicomponent fiber has a diameter between approximately five micrometers and approximately ten micrometers.

3. The bicomponent fiber of claim 1, wherein the bicomponent fiber is laminated to an expanded PTFE membrane, and the expanded PTFE membrane comprises a laminate.

4. The bicomponent fiber of claim 3, wherein the laminate comprises a portion of one of a filter bag and a pleated filter element.

5. The bicomponent fiber of claim 1, wherein the bicomponent fiber comprises a portion of one of a woven fabric and a needle felt fabric.

6. The bicomponent fiber of claim 1, wherein the bicomponent fiber remains stable in an environment having a temperature of at least approximately 250° C.

7. The bicomponent fiber of claim 1, wherein the bicomponent fiber remains stable in an environment having a pH of at most approximately 2.0.

8. A system for making a bicomponent fiber, the system comprising:
a container having an inlet and an outlet;
an aqueous dispersion within the container, wherein the aqueous dispersion includes polytetrafluoroethylene (PTFE); and
a heated surface configured to receive a core fiber coated with the aqueous dispersion from the outlet of the container, wherein the heated surface sinters the coated aqueous dispersion into a sheath.

9. The system of claim 8, further comprising a roller configured to direct the core fiber into the inlet of the container.

10. The system of claim 8, wherein the system is configured to yield a bicomponent fiber comprising:
a glass core; and
a PTFE sheath circumferentially enclosing the glass core;
wherein the bicomponent fiber has a diameter between approximately five micrometers and approximately twenty micrometers.

11. A process of making a bicomponent fiber, the process comprising:
passing a glass fiber through an aqeuous dispersion including polytetrafluoroethylene (PTFE) to coat the glass fiber with the aqueous dispersion, thereby yielding a PTFE coat of the glass fiber; and
contacting the PTFE coat of the glass fiber with a heated surface to form a PTFE sheath, wherein the PTFE sheath circumferentially encloses the glass fiber, thereby yielding the bicomponent fiber.

12. The process of claim 11, further comprising:
chopping the bicomponent fiber into staple fibers; and
forming a felted fabric from the staple fibers.

13. The process of claim 11, further comprising:
weaving the bicomponent fiber into a woven fabric.

14. The process of claim 13, further comprising:
laminating the woven fabric to an expanded PTFE membrane to form a laminate.

15. The process of claim 11, wherein the aqueous dispersion of PTFE includes approximately 60% PTFE.

16. The process of claim 11, wherein the PTFE coat of the glass fiber comprises approximately 20% by weight of the glass fiber.

17. The process of claim 11, further comprising:
adding a PTFE powder to a liquid to form the aqueous dispersion.

18. The process of claim 11, wherein the bicomponent fiber has a diameter between approximately five micrometers and approximately twenty micrometers.

19. The process of claim 11, further comprising:
forming a fabric from the bicomponent fiber;
laminating the fabric onto an expanded PTFE membrane to form a laminate structure; and
forming one of a filter bag and a pleated filter element from the laminate structure.

20. The process of claim 11, wherein the glass fiber comprises a texturized glass filament.
